(19) United States
(12) Patent Application Publication
(10) Pub. No.: US 2007/0182308 A1
(43) Pub. Date: Aug. 9, 2007

(54) BORATE CHLORIDE-BASED PHOSPHOR, AND LIGHT-EMITTING DIODE, FLUORESCENT LAMP AND PLASMA DISPLAY PANEL INCLUDING THE SAME

(75) Inventors: Xiaoqing ZENG, Yongin-si (KR); Seoung-jae IM, Seoul (KR); Byung-ki KIM, Gunpo-si (KR)

Correspondence Address: CANTOR COLBURN, LLP, 55 GRIFFIN ROAD SOUTH, BLOOMFIELD, CT, 06002, US

(73) Assignee: SAMSUNG ELECTRO-MECHANICS CO., LTD., Suwon-si (KR)

(21) Appl. No.: 11/608,921

(22) Filed: Dec. 11, 2006

(30) Foreign Application Priority Data
Feb. 7, 2006 (KR) 10-2006-0011837

(51) Int. Cl. H01J 63/04; H01J 1/62; C09K 11/08; C09K 11/61

(52) U.S. Cl. 313/485; 313/486; 252/301.4 H; 252/301.4 R

(57) ABSTRACT

Provided are a borate chloride phosphor represented by Formula 1 below, a light-emitting diode (LED) including the same, a lamp, a self-emissive liquid crystal display device (LCD), and a plasma display device (PDP).

(Ca_{(1-x-a-b-c)}BaₐSr_{b}Mg_{c}Euₓ)₂B₆O_{10.5}Cl,Formula 1
where 0<x≦0.2, 0≦a≦0.5, 0≦b≦0.95, 0≦c≦0.5. The borate chloride phosphor has good chemical properties and is thermally stable and easy to manufacture. The borate chloride phosphor exhibits high brightness due to a UV excitation light source in a wavelength of 280-410 nm, and emits blue light in a wavelength range of 425-455 nm. Accordingly, the borate chloride phosphor of the present invention can be applied to an LED, a lamp, a PDP, or a self-emissive LCD.

This application claims priority to Korean Patent Application No. 10-2006-0011837, filed on Feb. 7, 2006, and all the benefits accruing therefrom under 35 U.S.C. § 119(a), the content of which is incorporated herein by reference in its entirety.

### BACKGROUND OF THE INVENTION

1. Field of the Invention

The present invention relates to a borate chloride-based phosphor and a light-emitting diode (“LED”) including the same, a lamp, a self-emissive liquid crystal display device, and a plasma display panel (“PDP”). More specifically, the present invention relates to a borate chloride-based phosphor which exhibits high brightness due to a UV excitation light source and emits blue light wherein the range of the light-emitting wavelength can be controlled according to the content ratio of the material constituting the borate chloride phosphor, an LED, a lamp, a self-emissive liquid crystal display device, and a PDP including the same.

2. Description of the Related Art

White light-emitting diodes (LEDs) using semiconductors have a longer lifetime than incandescent lamps, and can be miniaturized and driven at low voltage. Hence, white LEDs have been highlighted as an alternative light source for home fluorescent lighting units and backlights of liquid crystal display devices.

A white LED can be realized in three ways as follows. First, white light can be provided by combining three LEDs emitting red, green, and blue light, which are the three basic colors of light. Second, white light can be provided by using a blue LED as a light source and exciting a yellow phosphor. Third, white light can be provided by using a UV-emitting LED and exciting RGB phosphors.

A white LED manufactured using the third method can be driven by a high current and has excellent color. Thus much research has been actively conducted into this method recently.

When realizing a white LED as described above, for example, Sr₅(PO₄)₃Cl:Eu is used as a blue phosphor, K₅Eu_{2.5}(WO₄)_{6.25}, La₂O₂S:Eu are used as red phosphors, and (Ba,Sr)₂SiO₄:Eu is used as a green phosphor in general.

However, of these, blue phosphor in particular has low light-emitting efficiency, thereby making it difficult to realize a white LED having high light-emitting efficiency.

### SUMMARY OF THE INVENTION

The present invention provides, in an embodiment, a borate chloride-based phosphor (also referred to herein as a “borate chloride phosphor”) emitting blue light having high light-emitting efficiency in a UV excitation light source, wherein the light-emitting wavelength range can be controlled according to the content ratio of the material constituting the borate chloride phosphor.

In another embodiment, a light-emitting diode (LED), a lamp, and a plasma display panel (PDP), and a self-emissive light-emitting liquid display device having high light-emitting efficiency.

In another embodiment, a borate chloride phosphor is represented by Formula 1 below.

(Ca_{(1-x-a-b-c)}BaₐSr_{b}Mg_{c}Euₓ)₂B₆O_{10.5}Cl, Formula 1

where 0<x≦0.2, 0≦a≦0.5, 0≦b≦0.95; 0≦c≦0.5.

In another embodiment, a white light emitting diode (LED) comprises: a light-emitting diode (LED); and the above described borate chloride phosphor.

In another embodiment, the excitation wavelength of the white LED may be from 280-410 nm, and the white LED may further comprise at least one of a green phosphor and a red phosphor.

In another embodiment, a lamp comprises the above described borate chloride phosphor.

In another embodiment, a self-emissive liquid crystal display device comprises the above described borate chloride phosphor.

In another embodiment, a plasma display panel (PDP) comprises the above described borate chloride phosphor.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a light-emitting diode (LED) according to an exemplary embodiment;

FIGS. 2 and 3 are cross-sectional views illustrating self-emissive liquid crystal display devices according to exemplary embodiments;

FIGS. 4 through 8 are graphs respectively illustrating X-ray diffraction (“XRD”) spectra of an exemplary phosphor produced according to Synthesis Examples 1 through 5;

FIG. 9 is a graph illustrating absorption spectra of an exemplary phosphor produced according to Synthesis Examples 1 through 5;

FIG. 10 is a light-emitting spectrum of an exemplary phosphor produced according to Synthesis Examples 1 through 5;

FIG. 11 is a graph illustrating absorption spectra of exemplary phosphors produced according to Synthesis Examples 1 and 2 and of a commercial blue phosphor; and

FIG. 12 is a graph illustrating light-emitting spectra of exemplary phosphors produced according to Synthesis Examples 1 and 2 and of a commercially available blue phosphor.

### DETAILED DESCRIPTION OF THE INVENTION

The present invention will now be described more fully with reference to the accompanying drawings, in which exemplary embodiments of the invention are shown.

It will be understood that when an element is referred to as being “on” another element or between other elements, it can be directly on the other element or intervening elements may be present therebetween. In contrast, when an element is referred to as being “disposed on” another element or “disposed between” other elements, the elements are understood to be in at least partial contact with each other, unless otherwise specified.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

According to an embodiment, a borate chloride phosphor represented by Formula 1 below is provided. The borate chloride phosphor has an absorption spectrum in an excitation wavelength range of 200-500 nm, specifically 280-410 nm, more specifically 360-410 nm, and good light-emitting efficiency in a peak wavelength range of 425-455 nm.

(Ca_{(1-x-a-b-c)}BaₐSr_{b}Mg_{c}Euₓ)₂B₆O_{10.5}Cl, Formula 3

where 0<x≦0.2, 0≦a≦0.5, 0≦b≦0.95, 0≦c≦0.5.

A blue phosphor according to an embodiment uses a borate chloride material as a host lattice, to which Eu²⁺ ions are doped as an activator. The borate chloride material has a rigid structure and a small phonon energy, and therefore is useful for radial ray transfer of the activator. Here, the Eu²⁺ ions absorb at vacuum ultraviolet (“VUV”) or UV light wavelengths depending on the host lattice type and structure, and emit UV or red light.

In an embodiment, the borate chloride phosphor of Formula 1 is a phosphor represented by Formulae 2 through 6 below:

(Ca_{(1-x-a-b)}BaₐSr_{b}Euₓ)₂B₆O_{10.5}Cl, Formula 2

where 0<x≦0.2, 0<a≦0.5, 0<b≦0.95.

(Ca₍₁₋ₓ₋ₐ₎BaₐEuₓ)₂B₆O_{10.5}Cl, Formula 3

where 0<x≦0.2, 0<a≦0.5.

(Ca_{(1-x-b)}Sr_{b}Euₓ)₂B₆O_{10.5}Cl, Formula 4

where 0<x≦0.2, 0<b≦0.95.

(Ca₍₁₋ₓ₎Euₓ)₂B₆O_{10.5}Cl, Formula 5

where 0<x≦0.2.

(Sr_{b}Euₓ)₂B₆O_{10.5}Cl, Formula 6

where 0<x≦0.2, 0<b≦0.95.

Examples of the phosphor represented by Formula 2 include Ca_{0.75}Ba_{0.1}Sr_{0.1}Eu_{0.05})₂B₆O_{10.5}Cl and Ca_{0.71}Ba_{0.1}Sr_{0.1}Eu_{0.09})2B₆O_{10.5}Cl. Examples of the phosphor represented by Formula 3 include (Ca_{0.75}Ba_{0.2}Eu_{0.05})₂B₆O_{10.5}Cl and (Ca_{0.5}Ba_{0.45}Eu_{0.05})₂B₆O_{10.5}Cl. Examples of the phosphor represented by Formula 4 include (Ca_{0.45}Sr_{0.5}Eu_{0.05})₂B₆O_{10.5}Cl, (Ca_{0.75}Sr_{0.2}Eu_{0.05})₂B₆O_{10.5}Cl, and (Ca_{0.81}Sr_{0.1}Eu_{0.09})₂B₆O_{10.5}Cl. Examples of the phosphor represented by Formula 5 include (Ca_{0.95}Eu_{0.05})₂B₆O_{10.5}Cl and (Ca_{0.91}Eu_{0.09})₂B₆O_{10.5}Cl. Examples of the phosphor represented by Formula 6 include (Sr_{0.95}Eu_{0.05})₂B₆O_{10.5}Cl and (Sr_{0.93}Eu_{0.07})₂B₆O_{10.5}Cl.

The method of manufacturing the borate chloride phosphor of Formula 1 of the present embodiment is not limited, and a solid phase method, a liquid phase method, or a gaseous phase method can be used. In the present embodiment, a phosphor manufactured using a solid phase method will be described.

A europium-containing compound, a borate compound, a chloride-containing compound, and up to a stoichiometric amount combined for each of at least one material selected from the group consisting of a calcium-containing compound, a barium-containing compound, a strontium-containing compound, and a magnesium-containing compound (i.e., up to a combined total of 1 molar equivalent of the at least one calcium, barium, strontium, and magnesium-containing compounds, per equivalent of chloride), and mixed. The mixture is pulverized when necessary and then dried and sintered in a first sintering at 300-700° C., specifically at 400-600° C.

Next, the compound after the first sintering is subject to a second sintering in a mixed gas atmosphere of hydrogen and nitrogen, and at a sintering temperature of 700-1000° C., specifically 800-900° C. The amount of the hydrogen in the mixed gas is adjusted to be 5-10 volume percent (vol %) based on the total amount of hydrogen and nitrogen.

Sintering is performed twice to remove impurities such as water, organic material, or complex compounds of salts contained in the mixture and to facilitate crystal growth. If the temperature used for the first sintering process is less than 300° C., it is not easy to grow crystals. If the temperature used for the first sintering process is greater than 700° C., unnecessary non-reaction material (i.e., side products) can form in the mixture of the above compounds. This can disturb the second sintering process rather than facilitating it, and the wavelength conversion efficiency can thereby be reduced.

If the temperature used for the second sintering process is less than 700° C., synthesis of the phosphor cannot be fully performed, and the desired light-emitting intensity in the UV wavelength region therefore cannot be obtained. If the temperature of the second sintering process is greater than 1,000° C., the mixture dissolves at these high temperatures, a glass; phase is formed, and the light-emitting intensity of the phosphor is diminished. Thus it is difficult to obtain a phosphor powder with desired properties.

CaCO₃ or CaCl₂.2H₂O can be used as the calcium-containing compound, BaCO₃ or BaCl₂ can be used as the barium-containing compound, SrCO₃ or SrCl₂.6H₂O can be used as the strontium-containing compound, and MgO or MgCO₃ can be used as the magnesium-containing compound. Eu₂O₃ can be used as the europium-containing compound; H₃BO₃ or: B₂O₃ can be used as the borate compound, and CaCl₂.2H₂O, SrCl₂.6H₂O, or BaCl₂ can be used as the chloride-containing compound.

An LED using the borate chloride phosphor of Formula 1 according to an embodiment will now be described.

First, red and green phosphors are mixed with the borate chloride phosphor of Formula 1 as described above to provide a phosphor composition.

Examples of the red phosphor are La₂O₂S:Eu, Sm (YOS:Eu) (see Korean Patent Publication No. 2005-74444), (Sr, Ca)₂P₂O₇:Eu,Mn, Y₂O₂S:Eᵤ,G_{d} (see Korean Patent Publication No. 2003-63211), and Ln₁₋ₐOX:Euₐ (Ln is La, Y or Gd, X is Br, Cl or F, and a is 0.005≦a<1.0) (see Korean Patent Publication No. 2003-95042).

The amount of the red phosphor can vary according to the light-emitting region to be realized. In an embodiment, the amount of red phosphor, is 10-40 parts by weight based on 1 part by weight of green phosphor, more specifically 25-35 parts by weight. If the amount of the red phosphor is outside this range, the color characteristic of the LEDs is not appropriate.

Examples of the green phosphor include (Ba,Sr)₂SiO₄:Eu, Ca8Mg(SiO₄)₄Cl:Eu,Mn, BaMgAl₁₀O₁₇:Eu,Mn, BaMg₂Al₁₆O₂₇:Eu,Mn, SrGa₂S₄:Eu, Ba₂SiO₄:Eu²⁺; Ba₂MgSi₂O₇:Eu²⁺, Ba₂ZnSi₂O₇:Eu²⁺; BaAl₂O₄:Eu²⁺; SrAl₂O₄:Eu²⁺, BaMg₂Al₁₆O₂₇:Eu²⁺, BaMg₂Al₁₆O₂₇:Eu²⁺,Mn²⁺ (see U.S. Pat. No. 6,278,135 B1), (Ba_{1-A-B-C},Ca_{A}Sr_{B}Eu_{C})₂(Mg_{1-W}Zn_{W})Si₂O₇(A+B+C≦1; C>0; 0.05≦W≦0.50) (example: Ba₂(Mg_{0.50}Zn_{0.50})Si₂O₇:Eu²⁺) (see U.S. Pat. No. 6,255,670 B1), LnₓBO₃:Ce_{3+y}, Tb_{3+z}[x=1−(y+z), 0<x<0.98, 0.01<y<0.5, 0.02<z<0.5, Ln: 1 or more of Sc, Y, La, Gd, or Lu, example: (Y_{0.39}Gd_{0.39})BO₃:Ce_{3+0.15},Tb_{3+0.07}] (see U.S. Pat. No. 6,469,322 B1), Ca₈Mg(SiO₄)₄Cl₂:Eu²⁺, Mn²⁺ (see U.S. Pat. No. 6,294,800 B1), MN₂S₄:Eu,Ce [M:Mg,Zn alone, or a mixture of the metal and a material selected from the group consisting of Ba, Sr, and Ca, N:Al, Ga alone or a mixture of a metal and a material selected from the group consisting of In, Y, La, and Gd, for example, ((Sr_{0.77}Zn_{0.23})_{0.85}Mg_{0.10}Eu_{0.05})Ga₂S₄] (see U.S. Patent Application Publication No. 2004/0124758 A1), Ca₃₍₁₋ₓ)Mg₃Si₄O₂₈:Euₓ [example: Ca_{2.94}Mg₃Si₄O₂₈:Eu_{0.02}] (see Japanese Patent Publication No. 2004-292569), ZnS:Cu,Al, Ca₂MgSi₂O₇:Cl, (Ba_{2-x-y-z-a}SrₓEu_{y}M_{z}Na)SiO_{4+d} (where M is at least one selected from the group consisting of La, Ce, Pr, Nd, Pm, Sm, Tb, Gd, Dy, Ho, Er, Tm, Yb, Lu, Y, Sc, Al, Ga, and In, N is at least one selected from the group consisting of Li, Na, and K) (see Korean Patent Publication No. 2001-26297).

The borate chloride phosphor of Formula 1 is used as a blue phosphor. In an embodiment, the amount of borate chloride phosphor varies depending on the light-emitting region (i.e., color space of light) to be realized, and can be 40-60 parts by weight based on 1 part by weight of the green phosphor, more specifically 45-55 parts by weight. If the amount of the blue phosphor is outside this range, the color characteristic of the LEDs is not appropriate.

An LED manufactured using the above-described composition has a high color rendering index of (0.33, 0.33), thus the LED can realize colors well and is substantially the same as natural light when used as an illumination light.

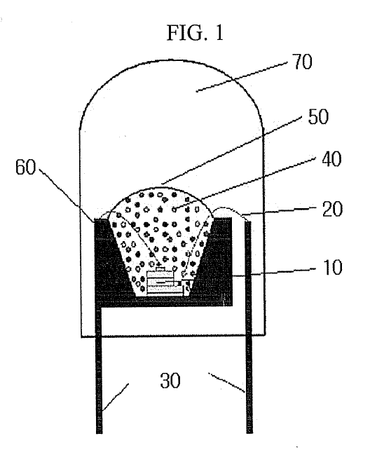

FIG. 1 is a schematic view of a surface mount type LED of a polymer lens type, according to an embodiment. Here, an epoxy lens is used as an example of the polymer lens.

Referring to FIG. 1, a UV LED chip 10 situated inside of a mold 60 is die-bonded to an electric lead line 30 through a gold wire 20, and an epoxy mold layer 50 which includes a phosphor composition 40 containing a blue phosphor is formed over UV LED chip 10. The inside of the mold 60 in FIG. 1 comprises a reflection layer (not shown) coated with aluminum or silver, which reflects the light emitted from the LED upward and confines an appropriate amount of epoxy.

A dome lens 70 is disposed over the epoxy mold layer 50. The shape of the dome lens 70 can be various according to the desired orientation angle.

The structure of the LED is not limited to that illustrated in FIG. 1, and other structures such as a structure in which a phosphor is mounted to the LED, a shell type, or a PCB type of a surface-mount type are also possible.

The borate chloride phosphor represented by Formula 1 can be applied not only to the above-described LED but to a lamp such as a quicksilver lamp, a xenon lamp, etc., a self-emissive liquid crystal display device (“LCD”), or a plasma display panel (“PDP”).

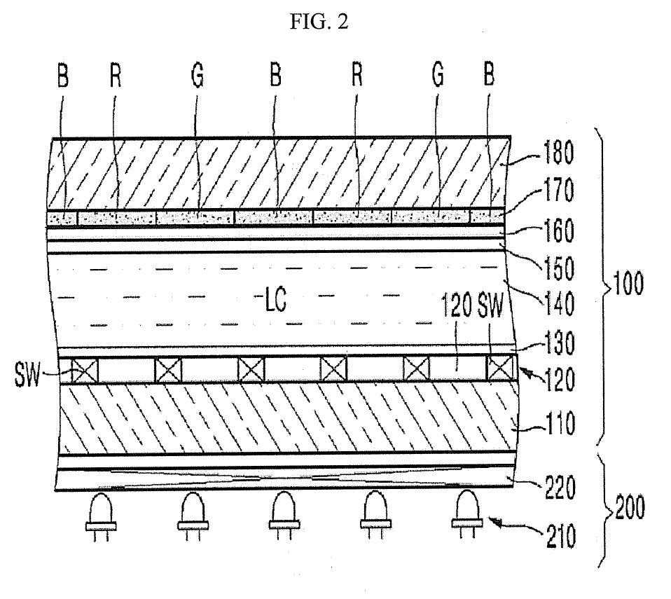

FIG. 2 is a cross-sectional view of a self-emissive liquid crystal display (LCD) according to an embodiment.

Referring to FIG. 2, the LCD according to the current embodiment includes a display panel 100 disposed on a UV backlight 200.

The UV backlight 200 comprises a UV LED having a wavelength of, for example, 280-410 nm. When manufacturing the UV LED, the borate chloride phosphor of Formula 1 is used. In the display panel 100, a front panel 180 and a rear panel 110 are spaced a predetermined distance apart from each other and a liquid crystal (“LC”) layer 140 is disposed in the space therebetween.

A light-emitting layer 170 including red, green, and blue light-emitting layers R, G, and B are disposed between the front panel 180 and a common electrode 160 and an upper orientation layer 150 is disposed on a surface of the common electrode opposite the light emitting layer 170. A thin film transistor (“TFT”) switching device SW as a liquid crystal driving circuit and a pixel electrode 120 are disposed between the rear panel 110, and a lower orientation layer 130. A polarization device (not shown) is also formed in front of the light-emitting layer 170 in the proceeding direction of the UV light. The light-emitting layer 170 includes quantum dots (QDs) in the form of particles or in the form of thin layers. In an embodiment, the QDs are included in the red light-emitting layer R, which has the lowest efficiency.

A UV filter (not shown), which is selectively included herein, is disposed on the surface of the front panel 180 opposite the light-emitting layer 170. The UV filter may be a chemical blocker absorbing UV light, or a physical blocker reflecting and dispersing the incident UV light.

The UV backlight 200 disposed on the outer surface of the rear panel 110 opposite the surface having switching device SW and pixel electrode 120, includes a UV lamp 210 and a light guide/diffusion member 220 disposed between the UV lamp 210 and the rear panel 110. The UV lamp 210 is a UV LED or a quicksilver lamp as described above. The light guide/diffusion member 220 guides light from the UV lamp 210 toward the rear panel 110 and diffuses the light uniformly.

The light guide/diffusion member 220 is selectively included, and when included, the UV lamp 210 has a size corresponding to the front surface of the rear panel 110, and when the UV lamp 210 is, for example, an LED, a plurality of LEDs are densely arranged on a plane. A light source supplying UV light over the entire surface of the LCD is needed to realize a large-size LCD.

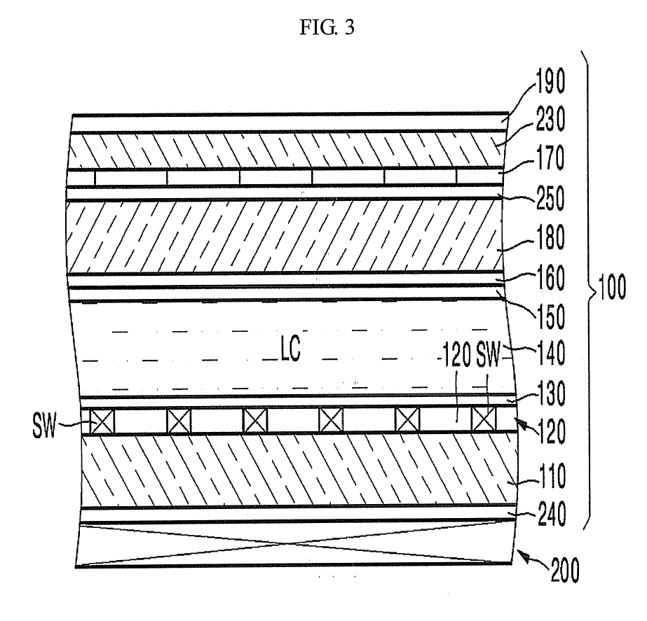

FIG. 3 is a schematic view of an LCD according to another embodiment. The difference between the LCD of FIG. 3 and the LCD of FIG. 2 lies in the location of the light-emitting layer 170 and the UV filter 190. Referring to FIG. 3, the LCD includes a display panel 100 and a UV backlight 200.

In the display panel 100, a front panel 180 and a rear panel 110 are spaced a predetermined distance apart from each other, and an LC layer 140 is disposed in the space therebetween.

A common electrode 160 is disposed between front panel 180 and an upper orientation layer 150, and the upper orientation layer is disposed between the common electrode 160 and LC layer 140. A switching device SW such as a TFT and a pixel electrode 120 are formed on and disposed between the rear panel 110 and a lower orientation layer 130, which is in turn disposed on a surface of the LC layer 140 opposite the upper orientation layer 150.

Polarization panels 250 and 240 are respectively disposed on the outer surfaces of the front panel 180 and the rear panel 110. As described above, a light-emitting layer 170 is disposed on a surface of the polarization panel 250 opposite front panel 180, which can allow color light to be realized by providing UV light. The light-emitting layer 170 realizes color light by absorbing UV light having a wavelength of 280-410 nm, and subsequent emission of light of the desired wavelengths by the respective R, G, and B phosphors. The light-emitting layer 170 is covered by a protection substrate 230 disposed on a surface of the light-emitting layer 170 opposite the polarization panel 250, and a UV filter 190 is formed on the outer surface of the protection substrate 230 opposite protection substrate 230.

The UV filter 190 may be a chemical blocker as described above or a physical blocker reflecting and dispersing the incident UV light.

Hereinafter, the present invention will be described in more detail with reference to the following examples. However, these examples are not intended to limit the scope of the invention.

### SYNTHESIS EXAMPLE 1

### Manufacture of (Ca_{0.95}Eu_{0.05})₂B₆O_{10.5}Cl

5.04 g of CaCO₃, 2.65 g of CaCl₂0.2H₂O, 0.633 g of Eu₂O₃, and 13.62 g of H₃BO₃ were mixed using an agate mortar. The mixture was heated in an air atmosphere at 600° C. for about 3 hours, and then heated again in an atmosphere of 10 volume percent (vol %) H₂ and 90 vol % N₂ at 850° C. for 3 hours. The obtained product was pulverized to provide (Ca_{0.95}Eu_{0.05})₂B₆O_{10.5}Cl powder.

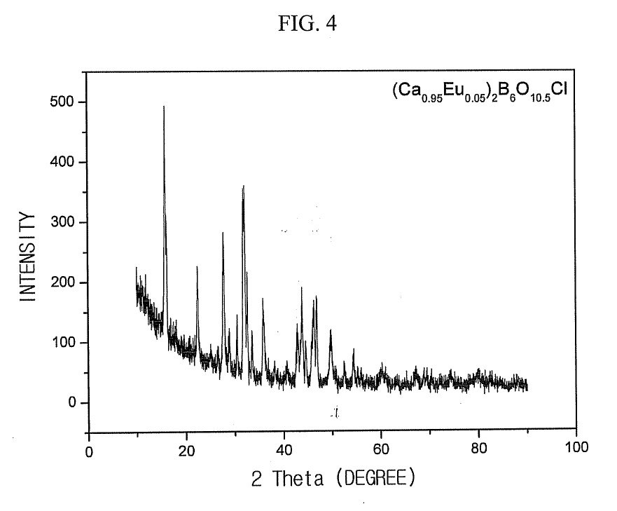

X-ray diffraction (“XRD”) analysis of the above powder was performed and an X-ray diffraction (XRD) spectrum produced as a result is illustrated in FIG. 4.

### SYNTHESIS EXAMPLE 2

### Manufacture of (Ca_{0.75}Ba_{0.2}Eu_{0.05})₂B₆O_{10.5}Cl

3.6 g of CaCO₃, 2.65 g of CaCl₂.2H₂O, 2.84 g of BaCO₃, 0.633 g of Eu₂O₃, and 13.62 g of H₃BO₃ were mixed using an agate mortar. The mixture was heated in an air atmosphere at 600° C. for about 3 hours, and then heated again in an atmosphere of 10 vol % H₂ and 90 vol % N₂ at 800-850° C. for 3 hours. The obtained product was pulverized to obtain (Ca_{0.75}Ba_{0.2}Eu_{0.05})₂B₆O_{10.5}Cl powder.

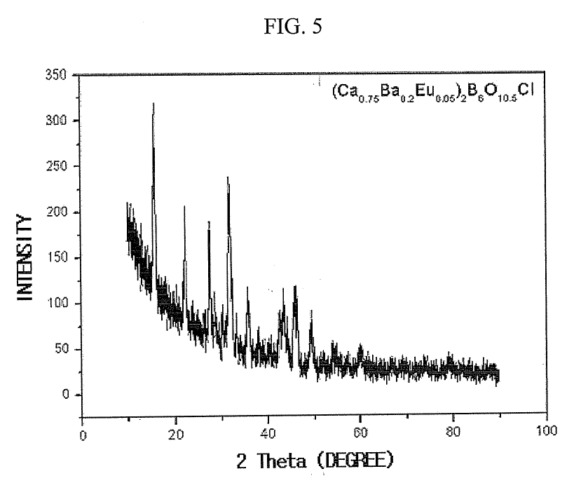

X-ray diffraction (XRD) analysis of the above powder was performed and an X-ray diffraction (XRD) spectrum produced as a result is illustrated in FIG. 5.

### SYNTHESIS EXAMPLE 3

### Manufacture of (Ca_{0.5}Ba_{0.45}Eu_{0.05})₂B₆O_{10.5}Cl

1.8 g of CaCO₃, 2.65 g of CaCl₂0.2H₂O, 6.4 g of BaCO₃, 0.663 g of Eu₂O₃, and 13.62 g of H₃BO₃ were mixed using an agate mortar. The mixture was heated in an air atmosphere at 600° C. for about 3 hours, and then heated again in an atmosphere of 10 vol % H₂ and 90 vol % N₂ at 800-850° C. for 3 hours. The obtained product was pulverized to obtain (Ca_{0.5} Ba_{0.45}Eu_{0.05})₂B₆O_{10.5}Cl powder.

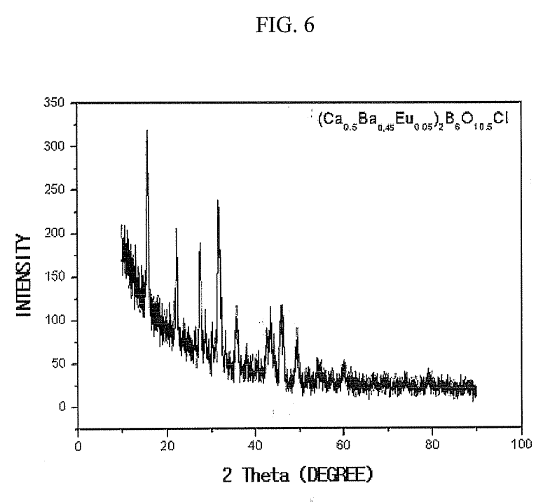

X-ray diffraction (XRD) analysis of the above powder was performed and an X-ray diffraction (XRD) spectrum produced as a result is illustrated in FIG. 6.

### SYNTHESIS EXAMPLE 4

### Manufacture of (Ca_{0.45} Sr_{0.5}Eu_{0.05})₂B₆O_{10.5}Cl

1.44 g of CaCO₃, 2.65 g of CaCl₂.2H₂O, 5.31 g of SrCO₃, 0.663 g of Eu₂O₃, and 13.62 g of H₃BO₃ were mixed using an agate mortar. The mixture was treated heated an air atmosphere at 600° C. for about 3 hours, and heated again in an atmosphere of 10 vol % H₂ and 90 vol % N₂ at 850-900° C. for 3 hours. The obtained product was pulverized to obtain (Ca_{0.45}Sr_{0.5}Eu_{0.05})₂B₆O_{10.5}Cl powder.

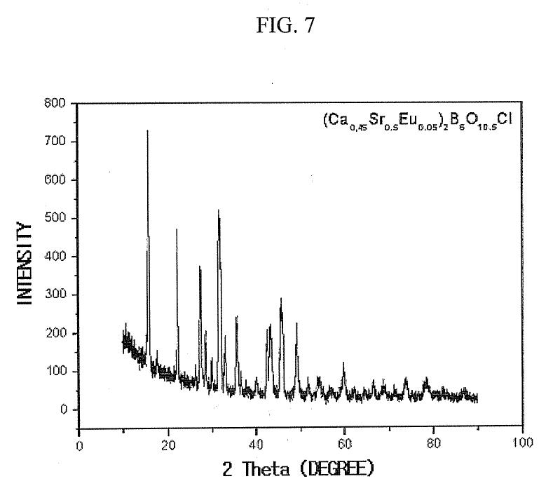

X-ray diffraction (XRD) analysis of the above powder was performed and an X-ray diffraction (XRD) spectrum produced as a result is illustrated in FIG. 7.

### SYNTHESIS EXAMPLE 5

### Manufacture of (Sr_{0.95}Eu_{0.05})₂B₆O_{10.5}Cl

7.44 g of SrCO₃, 4.8 g of SrCl₂.6H₂O, 0.663 g of Eu₂O₃, and 13.62 g of H₃BO₃ were mixed using an agate mortar. The mixture was heated in an air atmosphere at 600° C. for about 3 hours, and heated again in an atmosphere of 10 vol % H₂ and 90 vol % N₂ at 900-950° C. for 3 hours The obtained product was pulverized to obtain (Sr_{0.95}Eu_{0.05})₂B₆O_{10.5}Cl powder.

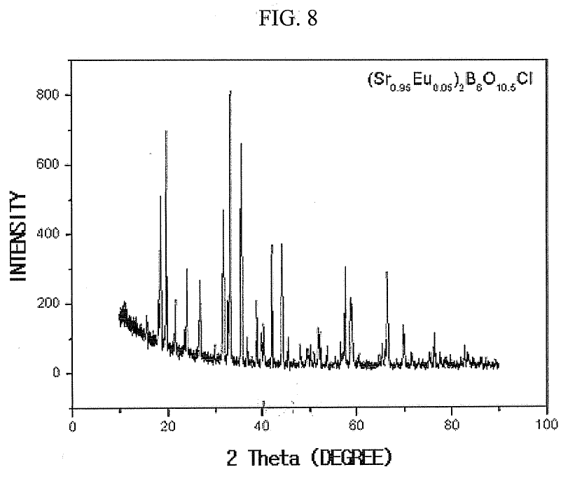

X-ray diffraction (XRD) analysis of the above powder was performed and an X-ray diffraction (XRD) spectrum produced as a result is illustrated in FIG. 8.

Referring to FIGS. 4 through 8, the structure of the compounds manufactured according to Synthesis examples 1 thorough 5 can be verified.

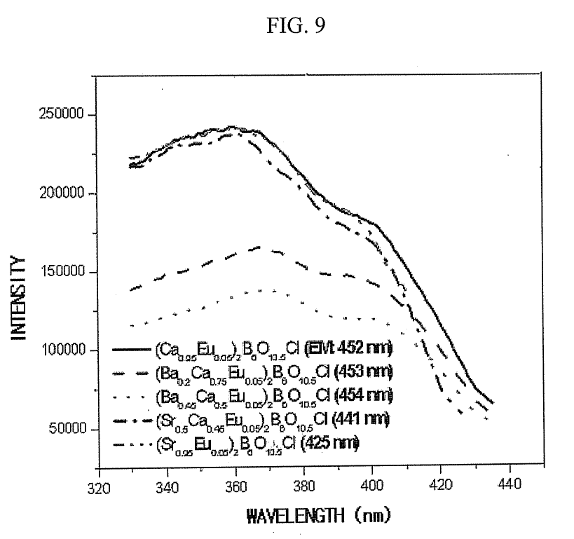

The absorption spectra of the phosphors manufactured according to Synthesis examples 1 through 5 were measured and are illustrated in FIG. 9.

In FIG. 9, the absorption cha characteristics of the phosphors manufactured according to Synthesis examples 1 through 5 in a wavelength range of 400-460 nm are shown.

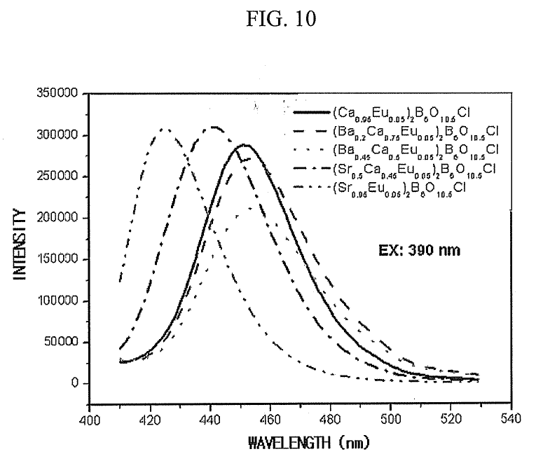

The light-emitting spectra of the phosphors manufactured according to Synthesis examples 1 through 5 were measured and are illustrated in FIG. 10.

FIG. 10 illustrates the light-emitting spectra of the phosphors manufactured according to Synthesis examples 1 through 5 having an excitation wavelength of around 390 nm. The wavelength of the phosphor can be adjusted to from 425-455 nm according to the composition ratio of the material constituting the phosphor. Thus the phosphor can be applied to various display devices.

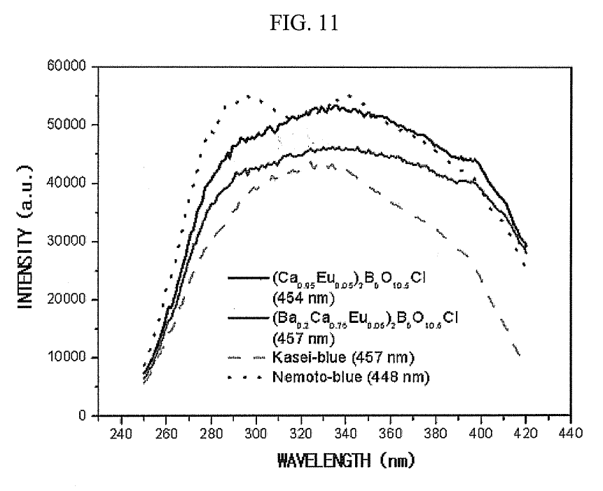

The absorption spectra of the phosphors manufactured according to Synthesis examples 1 and 2 and the commercially available comparative blue phosphors, BaMgAl₁₀O₁₇:Eu (Kasei-blue), and Sr₅(PO₄)₃Cl:Eu (Nemoto-blue) were measured and are illustrated in FIG. 11.

Referring to FIG. 11, the phosphors manufactured according to Synthesis examples 1 and 2 of the present invention show better absorption characteristics in a wider wavelength than Kasei-blue or Nemoto-blue.

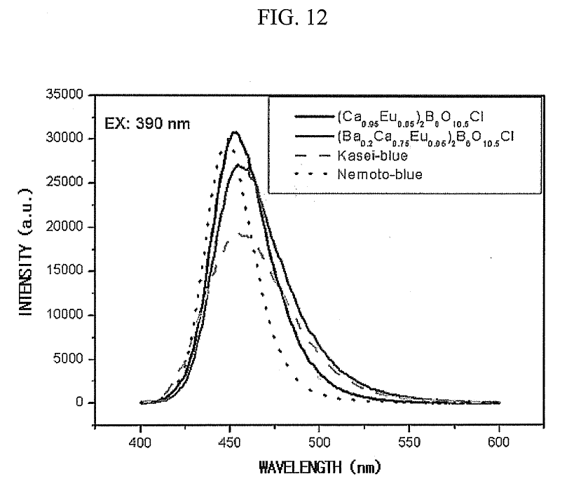

Also, the light-emitting spectra of the phosphors manufactured according to Synthesis examples 1 and 2 and the commercially available comparative blue phosphors, BaMgAl₁₀O₁₇:Eu (Kasei-blue) and Sr₅(PO₄)₃Cl:Eu (Nemoto-blue), were measured respectively and are illustrated in FIG. 12.

FIG. 12 illustrates the light-emitting spectra having an excitation wavelength of around 390 nm. The phosphors manufactured according to Synthesis examples 1 and 2 of the present invention exhibit better brightness than Kasei-blue and Nemoto-blue.

### EXAMPLE 1

### Manufacture of White LED

A white LED as in FIG. 1 was manufactured using (Ca_{0.95}Eu_{0.05})₂B₆O_{10.5}Cl manufactured according to Synthesis example 1 as a blue phosphor, (Sr,Ca)₂P₂O₇:Eu,Mn as a red phosphor, (Ba,Sr)₂SiO₄:Eu as a green phosphor, and using a UV LED (wavelength: ca. 390 nm) as an excitation light source.

The borate chloride phosphor represented by Formula 1 of the present invention is chemically and thermally stable, is easy to manufacture, has high brightness due to a UV LED excitation light source in a wavelength of 280-410 nm, and emits light in a wavelength range of 425-455 nm. Accordingly, the borate chloride phosphor can be applied to an LED, a lamp, a self-emissive LCD, or a PDP.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A borate chloride phosphor represented by Formula 1 below:
(Ca_{(1-x-a-b-c)}BaₐSr_{b}Mg_{c}Euₓ)₂B₆O_{10.5}Cl, Formula 1
where 0<x≦0.2, 0≦a≦0.5, 0≦b≦0.95, 0≦c≦0.5.

2. The borate chloride phosphor of claim 1, wherein the borate chloride phosphor is a phosphor represented by Formula 2 below:
(Ca_{(1-x-a-b)}BaₐSr_{b}Euₓ)₂B₆O_{10.5}Cl, Formula 2
where 0<x≦0.2, 0<a≦0.5, 0<b≦0.95.

3. The borate chloride phosphor of claim 1, wherein the borate chloride phosphor is a phosphor represented by Formula 3 below:
(Ca₍₁₋ₓ₋ₐ₎BaₐEuₓ)₂B₆O_{10.5}Cl, Formula 3
where 0<x≦0.2, 0<a≦0.5.

4. The borate chloride phosphor of claim 1, wherein the borate chloride phosphor is a phosphor represented by Formula 4 below:
Ca_{(1-x-b)}Sr_{b}Euₓ)₂B6O_{10.5}Cl, Formula 4
where 0<x≦0.2, 0<b≦0.95.

5. The borate chloride phosphor of claim 1, wherein the borate chloride phosphor is a phosphor represented by Formula 5 below:
(Ca₍₁₋ₓ₎Euₓ)₂B₆O_{10.5}Cl, Formula 5
where 0<x≦0.2.

6. The borate chloride phosphor of claim 1, wherein the borate chloride phosphor is a phosphor represented by Formula 6 below:
(Sr_{b}Euₓ)₂B₆O_{10.5}Cl, Formula 6
where 0<x≦0.2, 0<b≦0.95.

7. The borate chloride phosphor of claim 1, wherein the borate chloride phosphor is (Ca_{0.95}Eu_{0.05})₂B₆O_{10.5}Cl, (Ca_{0.75}Ba_{0.2}Eu_{0.05})₂B₆O_{10.5}Cl, (Ca_{0.5}Ba_{0.45}Eu_{0.05})₂B₆O_{10.5}Cl, (Ca_{0.45}Sr_{0.5}Eu_{0.05})₂B₆O_{10.5}Cl, (Sr_{0.95}Eu_{0.05})₂B₆O_{10.5}Cl.

8. A white light emitting diode (LED) comprising:
a light-emitting diode (LED); and
a borate chloride phosphor of claim 1.

9. The white LED of claim 8, wherein the excitation wavelength of the white LED is from 280-410 nm.

10. The white LED of claim 8, further comprising at least one of a green phosphor and a red phosphor.

11. A lamp comprising a borate chloride phosphor of claim 1.

12. A self-emissive liquid crystal display device comprising a borate chloride phosphor of claim 1.

13. A plasma display panel (PDP) comprising a borate chloride phosphor of claim 1.

14. A method of manufacturing a borate chloride phosphor comprising: mixing a europium-containing compound, a borate compound, a chloride-containing compound, and up to a stoichiometric amount combined for each of at least one material selected from the group consisting of a calcium-containing compound, a barium-containing compound, a strontium-containing compound, and a magnesium-containing compound,
sintering the mixture in a first sintering at a sintering temperature of 300-700° C., and
sintering the mixture in a second sintering at a sintering temperature of 700-1000° C.

15. The method of claim 14, wherein the second sintering is performed in a mixed gas atmosphere of hydrogen and nitrogen.

16. The method of claim 15, wherein the amount of the hydrogen in the mixed gas is adjusted to be 5-10 volume percent based on the total amount of hydrogen and nitrogen.

17. The method of claim 14, wherein the europium-containing compound is Eu₂O₃; the borate compound is H₃BO₃ or B₂O₃, and the chloride-containing compound is CaCl₂.2H₂O, SrCl₂.6H₂O, or BaCl₂.

18. The method of claim 14, wherein the calcium-containing compound is CaCO₃ or CaCl₂.2H₂O, the barium-containing compound is BaCO₃ or BaCl₂, the strontium-containing compound is SrCO₃ or SrCl₂.6H₂O, and the magnesium-containing compound is MgO or MgCO₃.

19. The method of claim 14, wherein the borate chloride phosphor prepared by the method is represented by Formula 1 below:
(Ca_{(1-x-a-b-c)}BaₐSr_{b}Mg_{c}Euₓ)₂B₆O_{10.5}Cl, Formula 1
where 0<x≦0.2, 0≦a≦0.5, 0≦b≦0.95, 0≦c≦0.5.
